(19) United States
(12) Patent Application Publication
(10) Pub. No.: US 2010/0229078 A1
(43) Pub. Date: Sep. 9, 2010

(54) CONTENT DISPLAY CONTROL APPARATUS, CONTENT DISPLAY CONTROL METHOD, PROGRAM, AND STORAGE MEDIUM

(76) Inventors: Yutaka Otsubo, Osaka (JP); Shinsuke Segawa, Osaka (JP); Masayoshi Kanbara, Osaka (JP); Tetsuo Kobayashi, Osaka (JP)

Correspondence Address: BIRCH STEWART KOLASCH & BIRCH, PO BOX 747, FALLS CHURCH, VA, 22040-0747, US

(21) Appl. No.: 12/681,173

(22) PCT Filed: Oct. 2, 2008
(86) PCT No.: PCT/JP2008/067943

§ 371 Date: Apr. 1, 2010

(30) Foreign Application Priority Data
Oct. 5, 2007 (JP) 2007-262669

(51) Int. Cl. G06F 17/00

(52) U.S. Cl. 715/203

(57) ABSTRACT

The content display control apparatus (1) reproduces moving image content in which captions and video images are correlated with each other by time stamps, thereby causing a display apparatus (5) to display the captions and the video images. In the reproduction, a caption display section (3) causes the display apparatus (5) to display the captions contained in the moving image content. On the other hand, a video image display section (4) causes the display apparatus (5) to display, in sync with that timing when the captions are displayed which is determined by the caption display section (3), the video images correlated with the captions. The content display control apparatus (1) thus reproduces the moving image content on the basis of the captions, thereby allowing a user to efficiently grasp contents of the moving image.

### TECHNICAL FIELD

The present invention relates to a content display control apparatus, a content reproduction method, a program, and a storage medium each of which allows a user to efficiently grasp contents of moving image content in which a piece of text data and a video image are correlated with each other by information (time stamp) for controlling a reproduction timing.

### BACKGROUND ART

Conventionally, movies are well known as captioned moving image content. Moreover, in these years, captioned broadcast programs are increasing for helping hearing-impaired people to understand contents of the broadcast programs without listening to sound.

In general, such a broadcast program in which captions and images are correlated with each other by respective time stamps is distributed to a video image reproduction device such as a television device. Moreover, with recent advancement in digital broadcasting technologies, such a broadcast program is also distributed as digital moving image data in which caption information which is digital text data and video image information which is digital video image data are correlated with each other by respective time stamps. In a case where the moving image content is stored on a hard disk, it is possible to repeat reproduction of the moving image content any number of times in which reproduction captions are displayed on a display screen in sync with moving images.

Some conventional techniques are also known which allow more sophisticated reproduction of captioned moving image content. For example, Patent Literature 1 discloses a video image search device which extracts a scene as below. First, the video image search device takes out caption information multiplexed with video image data, and stores the caption information together with the video images. Then, the video image search device detects, out of the stored caption data, a caption corresponding to a scene requested by a user. Then, the video image search device performs image analysis or sound analysis on a video image corresponding to a presentation timing of the caption, thereby extracting the requested scene. By utilizing the caption information, the video image search device makes it possible to extract the requested scene faster than conventional video image searching means which adopts only image or sound analysis.

Patent Literature 2 discloses an optical disk reproduction device. With the optical disk reproduction device, it is easy to efficiently search and review previous caption information during normal reproduction of captioned content. In addition, at a user's request, it is possible to perform control for finding a beginning of a scene containing previous caption information so that normal reproduction may be resumed therefrom.

### CITATION LIST

Patent Literature 1

Japanese Patent Application Publication, Tokukai, No. 2005-115607 A (Publication Date: Apr. 28, 2005)

Patent Literature 2

Japanese Patent Application Publication, Tokukai, No. 2007-158959 A (Publication Date: Jun. 21, 2007)

### SUMMARY OF INVENTION

However, the conventional arts have a problem in that a user cannot efficiently grasp contents of reproduced content. This is because captions are reproduced so as to be interlocked with reproduction of a moving image. In the case of such reproduction, a user tries to grasp contents of content by secondarily reading captions, while viewing moving image being reproduced. Accordingly, the user has to continuously view the moving image throughout in order to accurately grasp the contents. As a result, in the case of a 30-minute TV program, the user is required to take full 30 minutes of reproduction time. Therefore, in general, it is difficult to grasp the content in a shorter time.

On the other hand, a technique for increasing a reproduction speed of such moving image content is developed recent years. However, merely reproducing a moving image at a high speed cannot allow a user to recognize what is displayed. As a result, the user has difficulty in efficiently grasping contents of the moving image.

The present invention was made in view of the problems. An object of the present invention is to provide a content display control apparatus, a content display control method, a program, and a storage medium each of which is for performing display control so as to allow a user to efficiently grasp contents of content in which text data and a video image are correlated with each other by information (time stamp) for controlling a reproduction timing.

### Content Display Control Apparatus

In order to attain the object, a content display control apparatus of the present invention includes: text data display means for displaying a piece of text data; and video image display means for displaying a video image correlated with the piece of the text data by a time stamp, the video image display means displaying the video image in sync with a timing when the text data display means displays the piece of the text data.

According to the arrangement, the content display control apparatus displays the video image in sync with a timing when text data such as a caption is displayed. Specifically, the content display control apparatus causes a display apparatus to sequentially display pieces of text data, and meanwhile, causes the display apparatus to display a video image correlated with a piece of the text data to be displayed, in sync with a timing when the piece of the text data is displayed. Accordingly, the faster the reproduction speed of the text data, the faster the reproduction speed of the video image, and vice versa.

In moving image content, all the video images are not necessarily correlated with pieces of text data. In general, only a specific video image is correlated with a piece of text data. Accordingly, the moving image content has, in many places, a section in which video images correlated with no piece of text data continue for a certain time period.

Therefore, in a case where pieces of text data contained in moving image content are continuously reproduced, the content display control apparatus of the present invention does not display a video image correlated with no piece of text data. As a result, by reading pieces of text data which are continuously displayed, a user viewing the moving image content can skip video images correlated with no text data while grasping contents of the moving image. In other words, the user can grasp contents of the moving image content by merely viewing a part of the moving image.

As described above, the content display control apparatus allows a user to efficiently grasp contents of moving image content in which text data and a video image are correlated with each other by information (time stamp) for controlling a reproduction timing.

### Content Reproduction Method

In order to attain the object, a content reproduction method includes the steps of: displaying a piece of text data; and displaying, in sync with a timing when the piece of the text data is displayed, a video image correlated with the piece of the text data by a time stamp.

The arrangement above produces the same operation and effect as the content display control apparatus of the present invention.

### Program And Storage Medium

The content display control apparatus can be realized by a computer. In this case, the scope of the present invention encompasses (a) a program that realizes the content display control apparatus in a computer by causing the computer to operate as respective means and (b) a computer-readable storage medium in which the program is stored.

For a fuller understanding of the nature and advantages of the invention, reference should be made to the ensuing detailed description taken in conjunction with the accompanying drawings.

### BRIEF DESCRIPTION OF DRAWINGS

FIG. 1 is a block diagram illustrating a main part of a content display control apparatus of one embodiment of the present invention.

FIG. 2 is a diagram illustrating a moving image being reproduced by the content display control apparatus of the one embodiment of the present invention.

FIG. 3 is a diagram illustrating a screen image displayed on a display apparatus by the content display control apparatus of the one embodiment of the present invention.

FIG. 4 is a diagram illustrating an example in which the content display control apparatus of the one embodiment of the present invention extracts a plurality of topics from recorded content stored in a content database, and utilize the plurality of topics as video clips.

FIG. 5 is a diagram illustrating caption data in which time stamps and captions are correlated with each other.

FIG. 6 is a diagram illustrating a keyword list in which each of keywords contained in captions and corresponding appearance time are correlated with each other.

FIG. 7 is a diagram illustrating a plurality of topics which are defined by boundaries and contained in moving image content.

FIG. 8 is a diagram illustrating caption data in which topic numbers, time stamps, and caption information are correlated with each other.

FIG. 9 is a diagram illustrating a screen image containing, in the form of a list, topic information related to a plurality of topics.

FIG. 10 is a diagram illustrating a screen image containing a bar indicating a boundary between two topics.

### REFERENCE SIGNS LIST

1 Content display control apparatus

2 Display section (Time display means and caption information display means)

3 Caption display section (Caption display means)

4 Video image display section (Video image display means)

5 Display apparatus

6 Keyword extraction section

7 Topic-based chaptering section (Time section calculation means, topic boundary determining means, and topic production means)

8 Content database

### DESCRIPTION OF EMBODIMENTS

### Arrangement of Content Display Control Apparatus 1

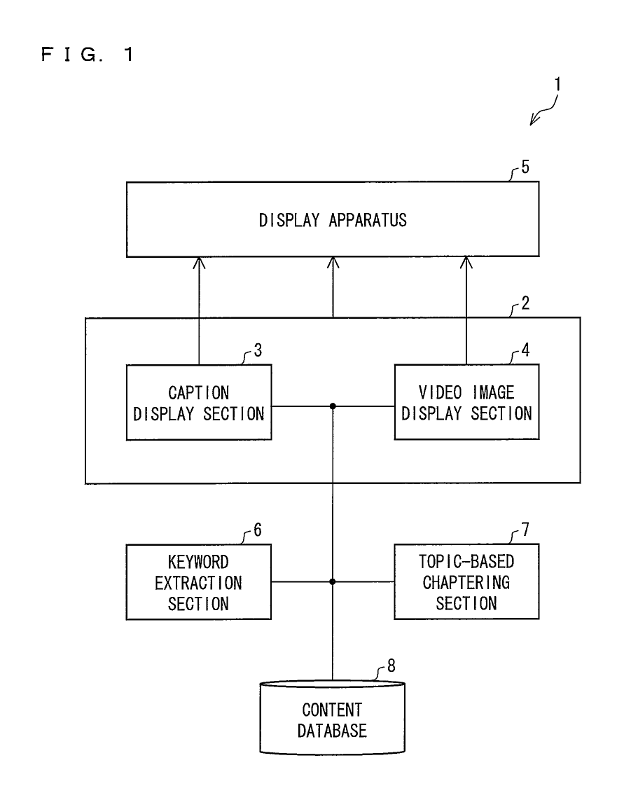

The following describes an arrangement of a content display control apparatus 1 according to the present invention, with reference to FIG. 1. FIG. 1 is a block diagram illustrating a main part of the content display control apparatus 1 according to one embodiment of the present invention. As illustrated in FIG. 1, the content display control apparatus 1 includes a display section 2, a caption display section 3 (text data display means), a video image display section 4 (video image display means), a keyword extraction section 6, a topic-based chaptering section 7 (topic production means), and a content database 8. The following describes in detail what function each of the members has.

### Caption-Based Moving Image Display

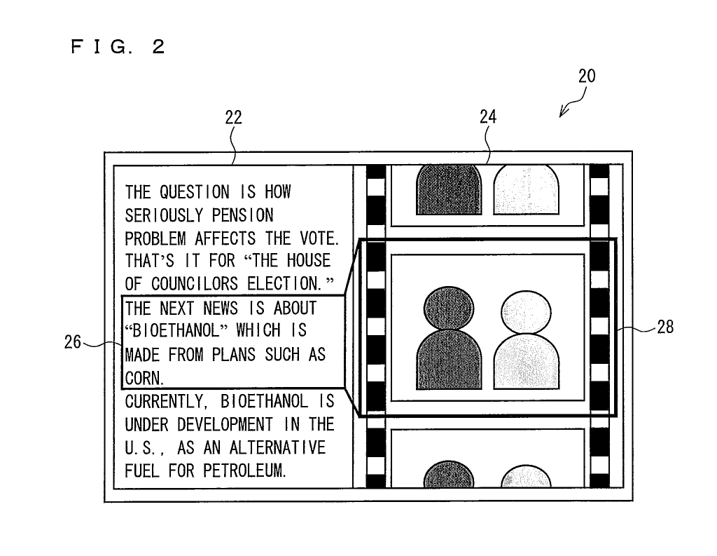

The following describes an overview of how the content display control apparatus 1 performs moving image reproduction, with reference to FIG. 2. FIG. 2 is a diagram schematically illustrating how the content display control apparatus 1 according to one embodiment of the present invention performs the moving image reproduction.

The content display control apparatus 1 of the present embodiment reproduces moving image content in which captions (text data) and video images are correlated with each other by respective time stamps. That is, the moving image content contains a plurality of captions and a plurality of video images constituting a moving image. At least one of the plurality of video images is correlated with a caption by a time stamp. The time stamp refers to information (time information) for controlling a reproduction timing of pieces of text data and captions.

Not all the video images are correlated with the captions but the moving image content also contains many video images correlated with no caption. The moving image content is stored (recorded, and/or saved) in the content database 8 in advance. In the content display control apparatus 1, the caption display section 3 causes a display apparatus 5 to display a caption and the video image display section 4 causes the display apparatus 5 to display a video image.

In the example of FIG. 2, the content display control apparatus 1 causes the display apparatus 5 to display a screen image 20 containing a caption group 22 and a moving image 24. The captions group 22 is made up of a plurality of captions such as a caption 26. The moving image 24 is made up of a plurality of video images such as a video image 28.

The captions of the caption group and the video images of the moving image 24 are correlated with each other by respective time stamps. In the example of FIG. 2, the caption 26 and the video image 28 are correlated with each other by a time stamp (not illustrated) indicating “3 minutes and 30 seconds.” Accordingly, in a case where the moving image content illustrated in FIG. 2 is reproduced by a conventional content display control apparatus, the moving image 28 and the caption 26 are reproduced after 3 minutes and 30 seconds elapse from the start of the reproduction.

On the other hand, the content display control apparatus 1 of the present embodiment carries out a reproduction process in which reproduction of a caption is synchronized with reproduction of a moving image, regardless of a time stamp for correlating the caption with the moving image. In the example of FIG. 2, the caption display section 3 sequentially arranges, on the screen image 20, the plurality of captions such as the caption 26 which are contained in the caption group 22, from a head (reproduction starting time) of the moving image content, so as to cause the display apparatus 5 to display the plurality of captions while scrolling them. On the other hand, in sync with a timing when the caption display section 3 displays a caption, the video image display section 4 causes the display apparatus 5 to display a video image correlated with the caption to be displayed. That is, the caption and the video image correlated therewith are simultaneously displayed on the display apparatus 5.

This allows a user to view moving image content in such a non-conventional style that, on the basis of captions, the user secondarily views a moving image. The faster the content display control apparatus 1 reproduces the captions, the faster the reproduction speed of the moving image, and vice versa.

In moving image content to be reproduced by the content display control apparatus 1, not all video images are correlated with captions. In general, only a specific video image is correlated with a caption. Accordingly, the moving image content has, in many places, a section in which video images correlated with no caption continue for a certain time period.

Therefore, in a case where captions in moving image content are continuously reproduced, the content display control apparatus 1 does not display a video image a caption to be displayed. As a result, by reading captions which are continuously displayed, a user viewing the moving image can skip video images correlated with no caption while grasping contents of the moving image. In other words, the user can grasp contents of the moving image content by merely viewing a part of the moving image.

As described above, the content display control apparatus allows a user to efficiently grasp contents of moving image content in which a caption and a video image are correlated with each other by a time stamp. As a result, the user can understand, e.g., contents of a news program, as the moving image content, in a short period of time. Moreover, the user also can quickly grasp an outline of a drama which the user has not viewed yet. Further, the user also can view only a part which is important to him, by extracting, from the moving image content, the part in such a manner that the user reads displayed captions and reproduces a video image and sound of a part in which he is interested.

### Example of Caption-Based Content Reproduction

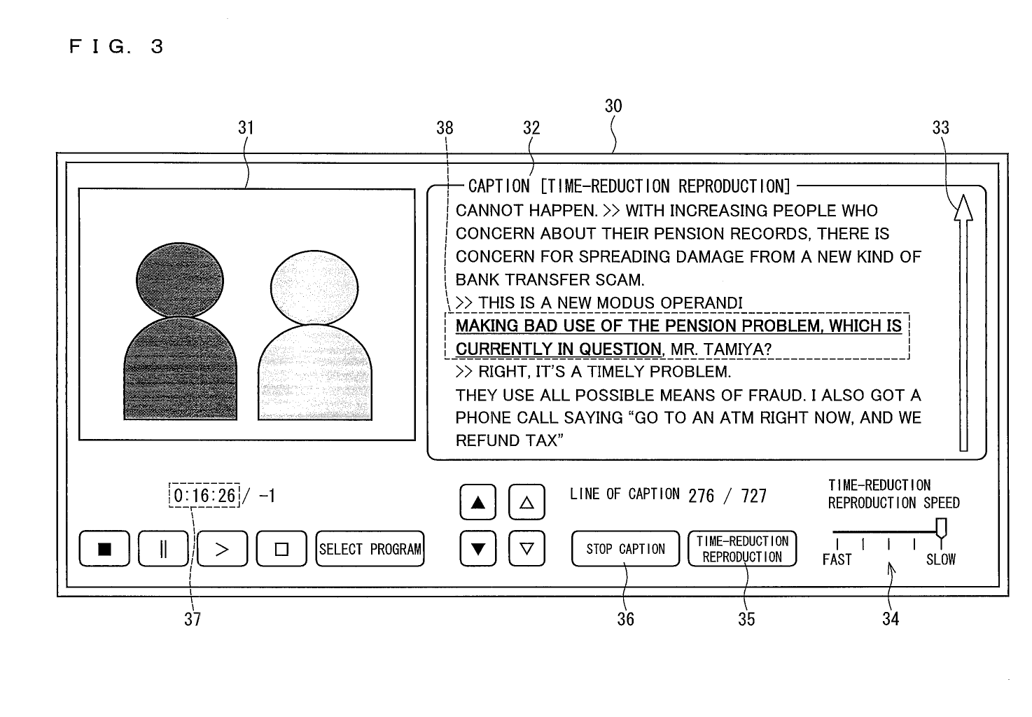

The following describes, in more detail, how the content display control apparatus 1 carries out caption-based reproduction of moving image content, with reference to FIG. 3. FIG. 3 is a diagram illustrating a screen image 30 displayed on the display apparatus 5 by the content display control apparatus 1 according to the one embodiment of the present invention.

In the example of FIG. 3, the content display control apparatus 1 causes the display apparatus 5 to display a display area for a caption and a display area for a video image correlated with the caption by a time stamp, so that the display areas do not overlap each other. More specifically, when the screen image 30 illustrated in FIG. 3 is displayed on the display apparatus 5, a list of a plurality of captions 32 contained in the moving image content is displayed, while being scrolled, in a right area of the screen image 30 as viewed against a display direction (in a right area as viewed from a viewer). On the other hand, a video image 31 correlated with any one of the currently-displayed captions is displayed in a left area of the screen image 30 as viewed against the display direction (in a left area as viewed from the viewer). That is, the plurality of captions are displayed in the display area for captions while at least one video image correlated with one of the plurality of captions by a time stamp is displayed in the display area for a video image. The plurality of captions are arranged in order of time stamps so as to be displayed.

More specifically, the caption display section 3 causes the display apparatus 5 to display a list of (i) a caption correlated with a certain time stamp and (ii) captions correlated with time stamps within predetermined time periods before and after the certain time stamp. On the other hand, the display section 2 causes the display apparatus 5 to display a video image indicated by the certain time stamp. The processes allow a user to read the list of the captions, whereby the user can quickly grasp contents which come before and after the currently-displayed video image. Accordingly, the user can grasp contents of the moving image content more quickly. Moreover, by reading the list of captions, the user can quickly find that part of the moving image content in which he is interested.

Moreover, captions are displayed in the right area of the screen image 30 and a video image (moving image) is displayed in the left area of the screen image 30. This allows the user to less move a gazing point when viewing a moving image while reading captions. As a result, the user can view the moving image content more easily.

In the case of FIG. 3, as indicated by an arrow 33, the caption display section 3 causes the display apparatus 5 to display the captions 32 while automatically scrolling the captions 32 from bottom to top of the screen image 30 as viewed from the user. Accordingly, the user does not need to perform key entry etc. for moving the captions forward. This allows the user to save trouble in grasping contents of the moving image.

The display section 2 of the content display control apparatus 1 causes the display apparatus 5 to display a speed adjustment bar 34 in the screen image 30. In a case where a user operates the speed adjustment bar 34, the caption display section 3 adjusts a display speed of the captions 32. Since a moving image is displayed in sync with a reproduction timing of each of the caption 32, the faster the reproduction speed of the captions 32, the faster the reproduction speed of the moving image. Conversely, the slower the reproduction speed of the captions 32, the slower the reproduction speed of the moving image.

The display section 2 causes the display apparatus 5 to display a button 35 in the screen image 30. In a case where the user presses the button 35 down, the content display control apparatus 1 carries out the caption-based reproduction process of the moving image content. That is, the video image display section 4 causes the display apparatus 5 to display a video image in sync with a timing when the caption display section 3 causes the display apparatus 5 to display a caption.

The display section 2 causes the display apparatus 5 to display a button 36 in the screen image 30. In a case where the user presses the button 35 down, the caption display section 3 stops to automatically scrolling the captions. Accordingly, the video image display section 4 also pauses the video image operation, whereby the video image display section 4 continues to display one video image in the screen image 30 without scrolling the video image. Furthermore, the display section 2 causes the display apparatus 5 to display a time stamp 37 in the screen image 30. The time stamp 37 indicates an elapsed time from a start of reproduction of moving image content. When the display section 2 causes the display apparatus 5 to display the time 37, the time stamp 37 is framed in a distinguishing frame which is the same as a distinguishing frame 38 displayed around the caption 38 which corresponds to the currently-displayed video image 31. In other words, the display section 2 causes the display apparatus 5 to display the time stamp 37 in the same manner that the caption display section 3 causes the display apparatus 5 to display the caption so that the caption may be distinguished from the other captions. That is, the display section 2 causes the display apparatus 5 to display the caption correlated with the currently-displayed video image by the time stamp, differently from the other captions.

The arrangement allows a user to grasp at a glance which one of the plurality of captions displayed in the form of a list is a caption describing the currently-displayed video image on the display apparatus 5. At the same time, the user also can view the time stamp of the caption. This allows the user to easily grasp how far the user has viewed the moving image content.

### Topic Contained In Content

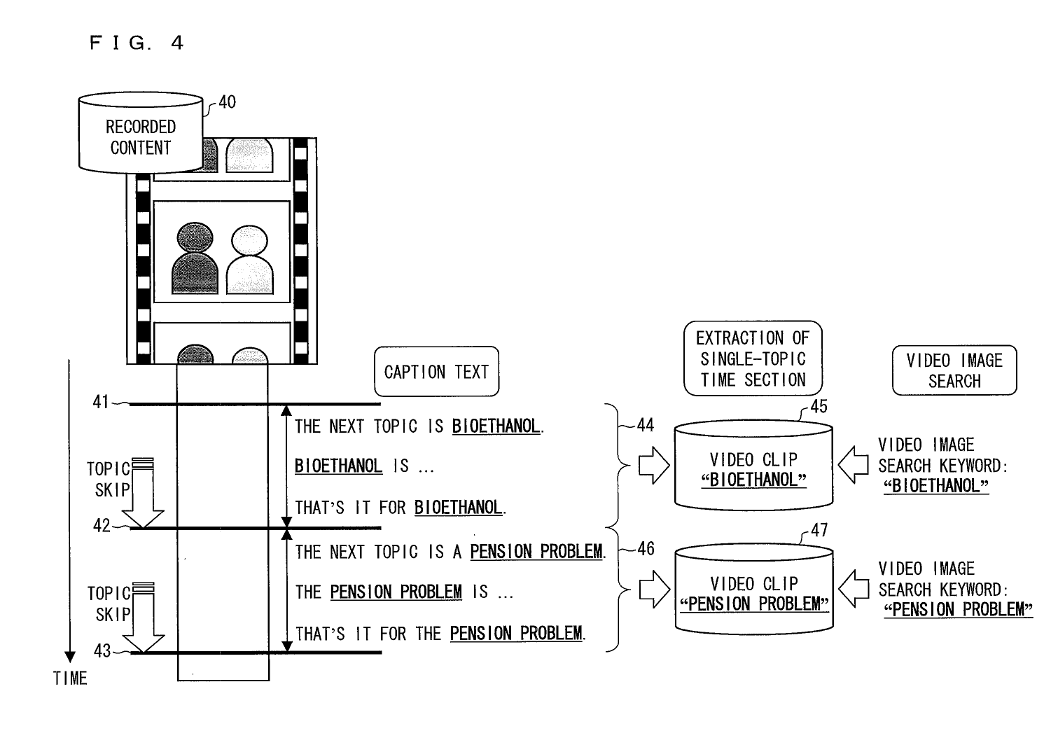

The content display control apparatus 1 not only carries out caption-based reproduction of moving image content, but also appropriately extracts a plurality of different topics contained in the moving image content, thereby allowing a user to view the moving image content on a topic-by-topic basis. The following describes this with reference to FIG. 4.

FIG. 4 is a diagram illustrating an example in which the content display control apparatus 1 extracts a plurality of topics from recorded content 40 stored in the content database 8, and the plurality of topics are utilized as video clips.

The recorded content 40 illustrated in FIG. 4 is a kind of the moving image content. That is, the recorded content 40 is data in which a caption and a video image are correlated with each other by a time stamp. A caption contained in a single piece of the recorded content 40 is not necessarily limited to one related to a single topic. Instead, captions which are related to respective different topics and which are different in contents tend to be contained in different time stamp periods of the recorded content 40, respectively, so that captions are contained in a cluster in each of the time stamp periods. In the case of a news program for example, topic contents vary for each news item to be broadcasted. Accordingly, contents of a corresponding moving image and contents of captions also vary considerably.

In the example of FIG. 4, the content display control apparatus 1 extracts two topics 44 and 46 from the recorded content 40. The topic 44 contains a list of captions each containing the keyword “bioethanol.” The topic 44 is positioned between boundaries 41 and 42 in the recorded content 40. Each of the boundaries 41 and 42 is indicative of a predetermined time stamp. The topic 46 contains (i) a series of captions each containing the keyword “pension problem” and (ii) moving images corresponding to the captions. The topic 46 is positioned between the boundaries 42 and 43 in the recorded content 40. As with the case of the boundaries 41 and 42, the boundary 43 is also indicative of a predetermined time stamp.

The content display control apparatus 1 determines the boundaries 41 through 43 in the recorded content 40 by carrying out a topic extraction process to be described later. Thus, the topics 44 and 46 are extracted from the recorded content 40. The topic 44 is stored in the content database 8 as a video clip 45 while the topic 46 is stored therein as a video clip 47. When stored, the video clip 45 is correlated with the text “bioethanol” while the video clip 47 is correlated with the text “pension problem”. Accordingly, in a case where a user enters the text “bioethanol” as a keyword for searching a topic, the content display control apparatus 1 retrieves the video clip 45 from the content database 8 and reproduces the video clip 45. On the other hand, in a case where the user enters the text “pension problem”, the content display control apparatus 1 retrieves the video clip 47 from the content database 8 and reproduces the video clip 47. That is, the content display control apparatus 1 is capable of quickly finding out and reproducing moving image content corresponding to a topic which the user wants to view.

The content display control apparatus 1 is also capable of carrying out a topic skip process during reproduction of the recorded content 40. Specifically, in a case where the content display control apparatus 1 receives a topic skip instruction from the user while the topic 44 starting from the topic boundary 41 is reproduced, the content display control apparatus 1 transfers a reproduction point to the next topic boundary 42 so as to start reproducing the topic 43. Similarly, in a case where the content display control apparatus 1 receives a topic skip instruction from the user while the topic 46 is reproduced, the content display control apparatus 1 transfers a reproduction point to the next topic boundary 43. By performing the topic skip process, the user can easily select and view a desired topic in the recorded content 40.

### Extraction Procedure of Topic

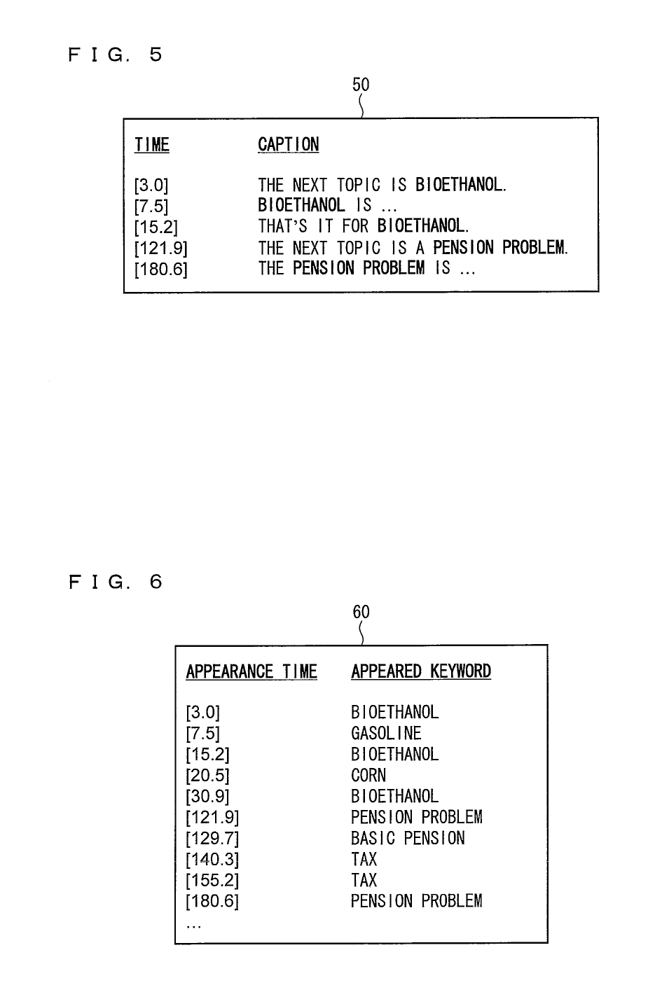

The following describes a processing procedure for the content display control apparatus 1 to extract a plurality of topics from moving image content, with reference to FIGS. 5 through 8.

FIG. 5 is a diagram illustrating caption data 50 in which time stamps and captions are correlated with each other. The caption data 50 is data constituting moving image content. That is, the time stamps contained in the caption data 50 are correlated with corresponding video images, respectively. Moreover, the captions contained in the caption data 50 cover a plurality of keywords as indicated by boldface in FIG. 5.

The content display control apparatus 1 determines a topic boundary of the text data, on the basis of one or more predetermined keywords. Specifically, the keyword extraction section 6 of the content display control apparatus 1 extracts a keyword from the caption data 50. In this process, for each of keywords, a time stamp corresponding to a caption containing the extracted keyword is extracted as an appearance time of the keyword, and the extracted keyword and appearance time are correlated with each other, thereby generating a predetermined keyword list 60. FIG. 6 is a diagram showing the keyword list 60 in which the keywords contained in the captions and appearance times of the keywords are correlated with each other. The keyword extraction section 6 supplies the generated keyword list 60 to the topic-based chaptering section 7.

### Topic

The topic-based chaptering section 7 extracts a topic from the moving image content with the use of the supplied keyword list 60. In the extraction, the topic-based chaptering section 7 extracts, as a single topic, a time section in which a keyword appears at a high frequency. This process is based on a fact that a keyword contained in a caption has a high tendency to differ between different topics.

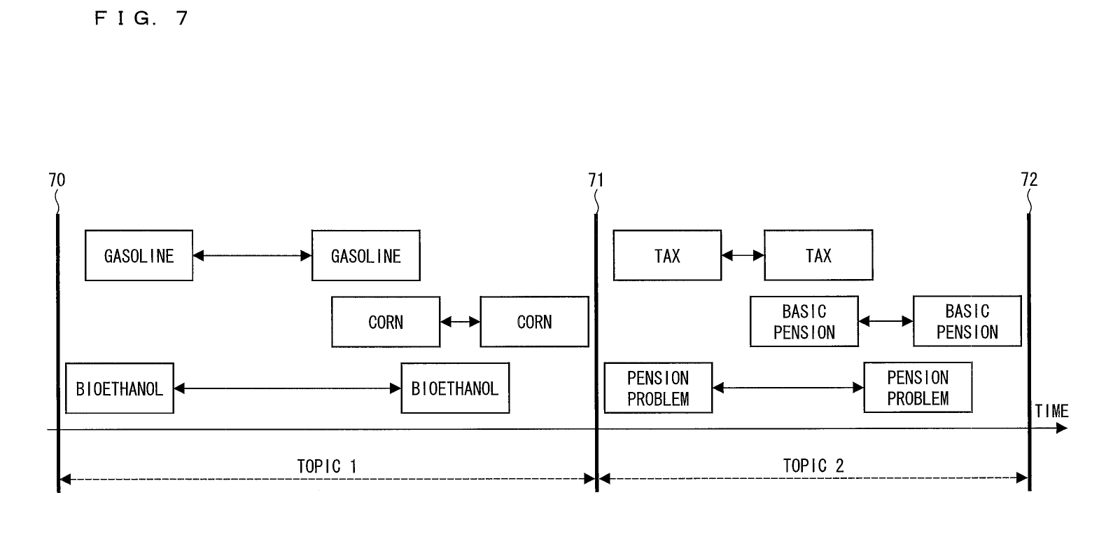

The following describes a process in which the content display control apparatus 1 extracts a topic from moving image content by utilizing a distribution of appearance frequencies of keywords, with reference to FIG. 7. FIG. 7 is a diagram illustrating those topics 1 and 2 defined by boundaries 70 through 72 which are contained in a single piece of moving image content. In FIG. 7, time stamps of the moving image content are indicated by the horizontal axis in chronological order. Each of square-framed keywords directly indicates at which time stamp in the moving image content the keyword appears. A section between the same keywords intends to an appearance section of the keyword. The topic-based chaptering section 7 carries out the processes with the use of the keyword list 60. For example, in a case where the keyword “gasoline” appears at a time stamp indicating 10 seconds and at a time stamp indicating 30 seconds in the moving image content, the topic-based chaptering section 7 deals with a time section from 10 seconds to 30 seconds as an appearance section of the keyword “gasoline”.

The topic-based chaptering section 7 carries out determination of an appearance section, for each of keywords contained in the keyword list 60. FIG. 7 schematically illustrates the results. As shown in FIG. 7, the number of coexisting appearance sections can be changed depending on a time stamp in such a manner that many appearance sections coexist at a certain time stamp while no coexisting appearance section resides at another time stamp. Particularly, appearance sections hardly coexist at a time stamp serving as a break (boundary) between two topics contained in the moving image content.

In view of this, among the plurality of time stamps of the moving image content, the topic-based chaptering section 7 determines, as topic boundaries, time stamps at each of which the number of co-existing time sections of respective keywords falls below a predetermined reference number (e.g., 1). In the example of FIG. 7, the boundaries 70 through 72 are determined. Further, the topic-based chaptering section 7 extracts a section between two adjacent topic boundaries in the moving image content as a topic contained in the moving image content. In the example of FIG. 7, a section between the boundaries 70 and 71 is extracted as the topic 1, and further, a section between the boundaries 71 and 72 is extracted as the topic 2.

As described above, the content display control apparatus 1 extracts a plurality of different topics from a single piece of moving image content by analyzing captions contained in the moving image content. This makes it possible to carry out selective reproduction for each topic, as shown in FIG. 4.

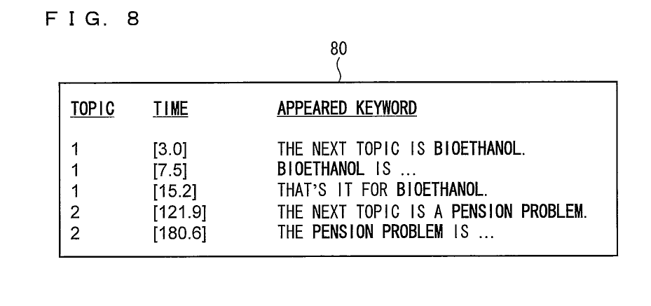

As to caption data in which captions and time stamps are correlated with each other, the content display control apparatus 1 carries out a process for correlating each of the captions with a topic number, i.e., the number of a topic containing the caption. With the process, for example, caption data shown in FIG. 8 is generated. FIG. 8 is a diagram showing caption data 80 in which topic numbers, time stamps, and pieces of caption information are correlated with each other. With reference to the caption data, the content display control apparatus 1 carries out the topic skip process. In a case where the topic skip process is carried out while the topic 1 in the moving image content is reproduced, a topic number (“1” in this case) is specified first which is correlated with a currently-displayed caption, with reference to the data shown in FIG. 8. Then, a caption is searched which is a first caption correlated with a next topic number (“2” in this case) of the specified topic number. Then, the reproduction of the moving image content is resumed from the found caption, thereby skipping the topic 1 to reproduce the topic 2.

### List Display of Topics

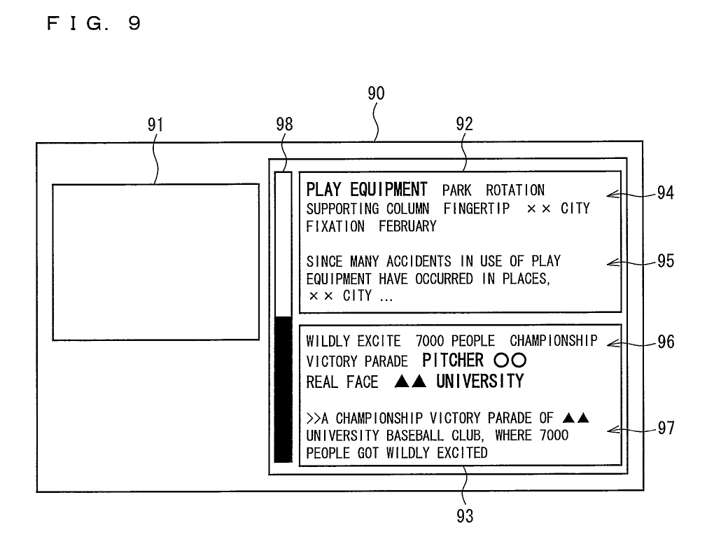

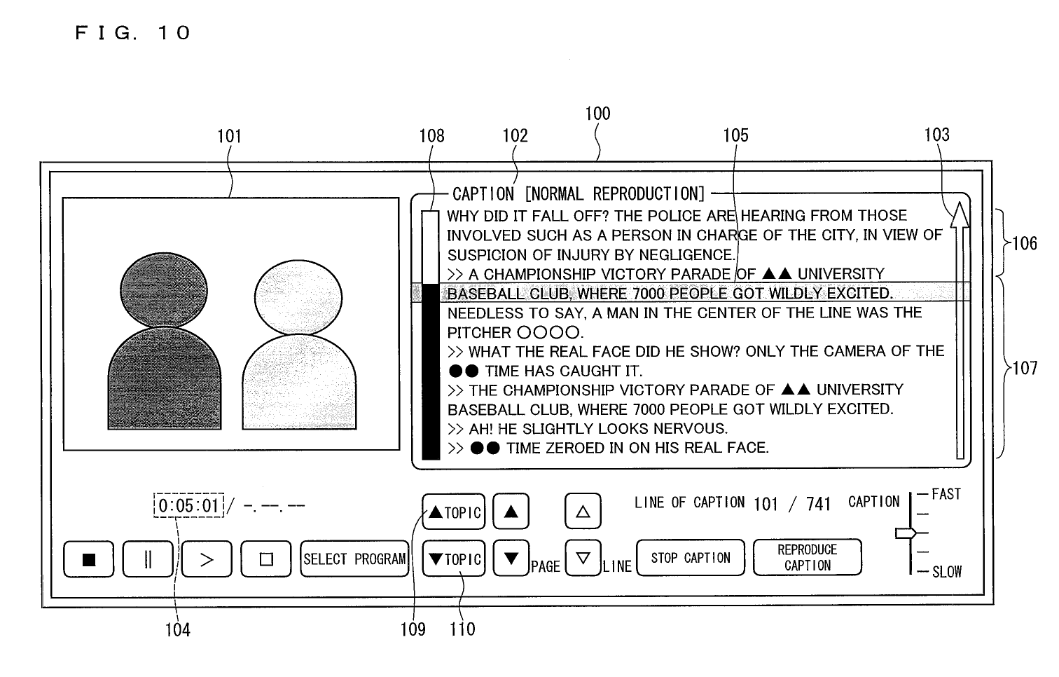

With the process above, the content display control apparatus 1 extracts a plurality of topics from a single piece of moving image content. In reproduction of the moving image content subjected to the topic extraction process, the content display control apparatus 1 also can allow a user to select a topic that he wants to view, by not reproducing first the moving image content from the beginning but displaying a list of information (related keywords, a part of a caption, etc.) related to topics contained in the moving image content. The following describes this example with reference to FIG. 9.

FIG. 9 is a diagram illustrating a screen image 90 containing a list of a plurality of pieces of topic information 92 and 93. In the example of FIG. 9, the display section 2 of the content display control apparatus 1 causes the display apparatus 5 to display the screen image 90. Specifically, a moving image 91 is displayed in a left area of the screen image 90 as viewed from a user. On the other hand, the topic information 92 and 93 are displayed in a right area of the screen image 90 as viewed from the user. The topic information 92 contains keywords 94 and a caption 95. On the other hand, the topic information 93 contains keywords 96 and a caption 97. The display section 2 displays a topic bar 98 for visually indicating a break between two topics, between (i) the moving image 91 and (ii) the topic information 92 and 93. The topic bar 98 is information which allows a user to easily distinguish different pieces of the topic information on the screen image 90. That is, in the topic bar 98, an area adjacent to the topic information 92 is displayed in white while an area adjacent to the topic information 93 is displayed in black. This allows a user to easily distinguish the topic information 92 from the topic information 93 on the screen image 90 by just recognizing the colors of the topic bar 98.

The moving image content shows, as keywords contained in each of the pieces of topic information, keywords which have been extracted from captions when topics have been extracted from the moving image content. In this process, a keyword which frequently appears in each topic and/or a keyword which appears earlier than the others can be displayed in a further emphasized manner (e.g., larger fonts, boldface, etc.), as compared to the other keywords. This allows a user to easily grasp contents of each topic. Moreover, it is possible to further improve viewability of a list display of a plurality of pieces of topic information, in such a manner that a part (e.g., only a beginning) of one of a plurality of captions contained in a topic is displayed under keywords as topic information.

As described above, the content display control apparatus 1 causes the display apparatus 5 to display, for each of the topics, a list of pieces of topic information related to a plurality of topics contained in moving image content. Specifically, the content display control apparatus 1 correlates at least one of a plurality of keywords contained in a topic with at least one of a plurality of captions contained in the topic, so as to display a list of the keyword and caption on the display apparatus 5. For example, the content display control apparatus 1 causes the display apparatus 5 to display, by each topic, keywords in order of their appearance frequencies. Further, the content display control apparatus 1 causes the display apparatus 5 to display a first caption contained in a topic. Further, by enclosing, with a line, a keyword and a caption of a common topic, the content display control apparatus 1 causes the display apparatus 5 to display the pieces of topic information in a distinguishable manner.

The displays allows a user to quickly grasp what topic the moving image content contains. Moreover, the user can also quickly select a topic in which he is interested.

### Visual Display of Break Between Topics

The following describes a screen image to be displayed when the content display control apparatus 1 reproduces moving image content divided into a plurality of topics, with reference to FIG. 10. FIG. 10 is a diagram illustrating a screen image 100 containing a bar 108 for indicating a break between topics 106 and 107.

When the content display control apparatus 1 causes the display apparatus 5 to display the screen image 100 illustrated in FIG. 10, a plurality of captions 102 contained in moving image content are displayed while being scrolled in the right area of the screen image 100 as viewed form a user. Meanwhile, a video image 101 correlated with any one of the currently-displayed captions is displayed in the left area of the screen image 100 as viewed form the user. As indicated by an arrow 103, the caption display section 3 causes the display apparatus 5 to display the captions 102 while automatically scrolling the captions 102 from bottom to top on the screen image 100.

The captions 102 are divided into those related to the topic 106 and those related to the topic 107. That is, the example of FIG. 10 shows that the content display control apparatus 1 causes the display apparatus 5 to display the captions 102 containing a break between topics. Accordingly, the display section 2 causes the display apparatus 5 to display the topic bar 108 indicative of the break on the left edge of the captions 102. The topic bar 108 in the screen image 100 is information which allows a user to easily distinguish captions which corresponds to different topics, respectively. In the topic bar 108, an area adjacent to captions contained in the topic 106 is displayed in while an area adjacent to captions contained in the topic 107 is displayed in black. This allows a user to easily determine, by just recognizing the colors of the topic bar 108, whether the currently-displayed plurality of captions are contained in a same topic or in different topics. Moreover, by checking a border between the colors of the topic bar 108, the user can easily locate a boundary between the topics.

The display section 2 causes the display apparatus 5 to display a time stamp 104 on the screen image 100. The time stamp indicates an elapsed time from a start of reproduction of the moving image content. The display section 2 causes the display apparatus 5 to display, on the screen image 100, a background 105 of a caption correlated with the time stamp 104, so that the background 105 may be distinguished from backgrounds for the other captions. Accordingly, by viewing the background 105, the user can grasp at a glance which one of the plurality of captions displayed in the form of a list is a caption describing the currently-displayed video image on the display apparatus 5. Moreover, at the same time, the user can view the time stamp of the caption. As a result, the user can easily grasp how far he has viewed the moving image content.

The display section 2 causes the display apparatus 5 to display a button 109 in the screen image 100. In a case where a user presses the button 109 down, the content display control apparatus 1 carries out the topic skip process (a skip process for skipping the moving image content toward its reproduction starting time). That is, a topic to be reproduced is switched to one preceding a currently-reproduced topic.

The display section 2 causes the display apparatus 5 to display a button 110 on the screen image 100. In a case where the user press the button 110 down, the content display control apparatus 1 carries out the topic skip process (a skip process for skipping the moving image content toward its reproduction ending time). That is, a topic to be reproduced is switched to one following the currently-reproduced topic.

Note that the present invention is not limited to the description of the embodiments above, but can be altered by a skilled person in the art within the scope of the claims. An embodiment derived from a proper combination of technical means disclosed in respective different embodiments is also encompassed in the technical scope of the present invention.

### Temporary Stop of Caption

For example, the caption display section 3 may be arranged such that: while input means (not illustrated) for detecting a user's input operation detects the input operation, the caption display section 3 reproduces a caption at a speed that depends on a detected amount, and, after the input means ends the detection of the input operation, the caption display section 3 reproduces a caption, without scrolling the caption, for a predetermined time period, and then, resumes the automatic reproduction of the caption. In this case, after the user's input operation is finished, the caption is displayed for the predetermined time period, without being scrolled. Then, the caption is reproduced while being automatically scrolled. Accordingly, after the user finishes the input operation, the user can easily find a caption that he should start to read. This helps the user to easily read the caption.

The content display control apparatus 1 may further include adjustment means for adjusting a display reproduction speed of captions in accordance with a user input.

### Display of Blank Line

The caption display section 3 preferably changes a distance or distances between captions, in accordance with time periods between time stamps of the captions. As one example of this, it is preferable to display a blank line between one caption and a next caption in a case where a time period between a time stamp of the one caption and a time stamp of the next caption exceeds a predetermined reference time period. In this case, by recognizing the blank line, a user can know that a certain time period resides between the two captions. The reference time period is preferably not less than 45 seconds. The caption display section 3 finds the time period between the time stamp of the one caption and the time stamp of the next caption by sequentially searching out (i) each of a plurality of captions contained in moving image content and (ii) each of time stamps which are correlated with the plurality of captions, respectively. For example, in a case where a caption A is correlated with a time stamp indicating 2 minutes and 50 seconds, and a next caption B is correlated with a time stamp indicating 5 minutes and 50 seconds, the caption display section 3 determines that a time period between the two captions is 3 minutes. Accordingly, one blank line is displayed between the captions A and B when the captions A and B are sequentially displayed on the display apparatus 5.

### Program And Storage Medium

The blocks of the content display control apparatus 1 may be realized by way of hardware. Otherwise, the blocks may be realized by way of software as executed by a CPU (Central Processing Unit) as follows:

The content display control apparatus 1 includes a CPU and a memory device (memory medium). The CPU executes instructions in a program realizing the functions. The memory device may be a ROM (Read Only Memory) which contains the program, a RAM (Random Access Memory) to which the program is loaded so as to be in an executable format, and/or a memory containing the program and various data. With the arrangement, the object of the present invention can also be achieved by a predetermined storage medium.

The storage medium stores, in a computer-readable manner, program code (executable program, intermediate code program, or source program) for the content display control apparatus 1 which program code is software realizing the aforementioned functions. The storage medium is mounted to the content display control apparatus 1. Accordingly, the content display control apparatus 1 serving as a computer reads (or, the CPU or an MPU reads) out and executes the program code stored in the mounted storage medium.

A storage medium for supplying the program code to the content display control apparatus 1 is not limited to one of a specific structure or type. That is, the storage medium may be, for example, a tape, such as a magnetic tape or a cassette tape; a magnetic disk, such as a floppy® disk or a hard disk, or an optical disk, such as CD-ROM/MO/MD/DVD/CD-R; a card, such as an IC card (incl. memory card) or an optical card; or a semiconductor memory, such as a mask ROM/EPROM/EEPROM/flash ROM.

The object of the present invention can also be achieved by arranging the content display control apparatus 1 so that the content display control apparatus 1 may be connectable to a communications network. In this case, the program code is supplied to the content display control apparatus 1 via the communications network. The communications network is not limited to one of a specific type or form, provided that the program code can be supplied to the content display control apparatus 1 via the communications network. For example, the communications network may be the Internet, an intranet, extranet, LAN, ISDN, VAN, CATV communications network, virtual dedicated network (Virtual Private Network), telephone line network, mobile communications network, or satellite communications network.

The transfer medium which makes up the communications network is not limited to one of a specific arrangement or type but can be any medium, provided that the program code can be transmitted via the medium. For example, the transfer medium may be wired line, such as IEEE 1394, USB (Universal Serial Bus), electric power line, cable TV line, telephone line, or ADSL (Asymmetric Digital Subscriber Line) line; or wireless, such as infrared radiation (IrDA, remote control), Bluetooth®, 802.11 wireless, HDR, mobile telephone network, satellite line, or terrestrial digital network. The present invention can be also realized by the program code in the form of a computer data signal embedded in a carrier wave which is embodied by electronic transmission.

Further, the content display control apparatus of the present invention is preferably arranged such that a text data display area where the piece of the text data is displayed and a video image display area where the video image correlated with the piece of the text data by the time stamp are displayed so as not to overlap each other.

Further, the content display control apparatus of the present invention is preferably arranged such that the text data display means displays a plurality of pieces of text data in the text data display area; and the video image display means displays, in the video image display area, at least one video image correlated with one of the plurality of pieces of text data by a time stamp.

Further, the content display control apparatus of the present invention is preferably arranged such that the plurality of pieces of text data encompass a plurality of pieces of text data correlated with respective different time stamps.

Further, the content display control apparatus of the present invention is preferably arranged such that the text data display means arranges, in order of the time stamps, the plurality of pieces of text data so as to display the plurality of pieces of text data.

According to the arrangements, a user can read a plurality of pieces of text data, within one screen image. This allows the user to quickly grasp contents which come before and after a currently-displayed video image. Accordingly, the user can grasp contents of moving image content more quickly. Further, by reading the plurality of displayed pieces of text data, the user can quickly find that place in the moving image content in which the user is interested.

Further, the content display control apparatus of the present invention is preferably arranged such that in accordance with intervals of the time stamps, the text data display means changes intervals at which the plurality of pieces of text data are arranged.

According to the arrangement, a user can know that a certain time period resides between two pieces of text data.

Further, the content display control apparatus of the present invention is preferably arranged such that the text data display means displays (i) the one piece of text data correlated with the currently-displayed video image by the time stamp and (ii) another piece of text data differently from each other.

According to the arrangement, a user can grasp, at a glance, which one of a plurality of currently-displayed pieces of text data is a piece of text data corresponding to a currently-displayed video image.

Further, the content display control apparatus of the present invention is preferably arranged such that the video image display means interlocks a display reproduction speed of the video image with a display reproduction speed of the piece of the text data.

Further, the content display control apparatus of the present invention preferably further includes adjustment means for adjusting the display reproduction speed of the piece of the text data in accordance with a user input.

### Topic Production

Further, the content display control apparatus of the present invention preferably further includes a topic-based chaptering section for determining a topic boundary of the piece of the text data on the basis of one or more predetermined keywords.

According to the arrangement, the content display control apparatus extracts contents of moving image content by cutting the moving image content into topic portions. Each of the topic portions is a set of a moving image and a piece of text data which are related to a specific field. This makes it possible to search and reproduce, topic by topic, a content of the moving image content. Accordingly, a user can select and view only a content related to a topic in which the user is interested. As a result, the user can efficiently view the moving image content.

As described above, the content display control apparatus of the present invention includes: text data display means for displaying a piece of text data; and video image display means for displaying a video image correlated with the piece of the text data by a time stamp, the video image display means displaying the video image in sync with a timing when the text data display means displays the piece of the text data. This allows a user to efficiently grasp contents of moving image content in which a piece of text data and a video image are correlated with each other by information (time stamp) for controlling a reproduction timing.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention can be widely used as a content display control apparatus for controlling how to display content (e.g., a broadcast program) in which a caption and a moving image are correlated with each other by a time stamp.

1-13. (canceled)

14. A content display control apparatus comprising:
text data display means for displaying a piece of text data; and
video image display means for displaying a video image correlated with the piece of the text data by a time stamp,
the video image display means displaying, except for a video image correlated with no piece of text data by a time stamp, the video image correlated with the piece of the text data by the time stamp, in sync with a timing when the text data display means displays the piece of the text data.

15. The content display control apparatus as set forth in claim 14, wherein a text data display area where the piece of the text data is displayed and a video image display area where the video image correlated with the piece of the text data by the time stamp is displayed are displayed so as not to overlap each other.

16. The content display control apparatus as set forth in claim 15, wherein:
the text data display means displays a plurality of pieces of text data in the text data display area; and
the video image display means displays, in the video image display area where the video image correlated with the piece of the text data by the time stamp is displayed, at least one video image correlated with one of the plurality of pieces of text data by a time stamp.

17. The content display control apparatus as set forth in claim 16, wherein the plurality of pieces of text data encompass a plurality of pieces of text data correlated with respective different time stamps.

18. The content display control apparatus as set forth in claim 17, wherein the text data display means displays the plurality of pieces of text data arranged in order of the time stamps.

19. The content display control apparatus as set forth in claim 18, wherein in accordance with intervals of the time stamps, the text data display means changes a distance or distances between the plurality of pieces of text data.

20. The content display control apparatus as set forth in claim 16, wherein the text data display means displays (i) the one piece of text data correlated, by the time stamp, with the currently-displayed video image correlated with the one piece of the text data by the time stamp and (ii) another piece of text data differently from each other.

21. The content display control apparatus as set forth in claim 14, wherein the video image display means interlocks, with a display reproduction speed of the piece of the text data, a display reproduction speed of the video image correlated with the piece of the text data by the time stamp.

22. The content display control apparatus as set forth in claim 14, further comprising adjustment means for adjusting a display reproduction speed of the piece of the text data in accordance with a user input.

23. The content display control apparatus as set forth in claim 14, further comprising a topic-based chaptering section for determining a topic boundary of the piece of the text data on the basis of one or more predetermined keywords.

24. A content display control method comprising the steps of:
displaying a piece of text data; and
displaying, except for a video image correlated with no piece of text data by a time stamp, a video image correlated with the piece of the text data by a time stamp, in sync with a timing when the piece of the text data is displayed.

25. A program for causing a content display control apparatus recited in claim 14 to operate, the program for causing a computer to function as respective means.

26. A computer-readable storage medium in which a program recited in claim 25 is stored.
